(19) United States
(12) Patent Application Publication
(10) Pub. No.: US 2012/0318936 A1
(43) Pub. Date: Dec. 20, 2012

(54) Stand for supporting a flower or plant

(76) Inventors: Theodore A. Lutz, Sewickley, PA (US); Lillian M. Lutz, Sewickley, PA (US)

(21) Appl. No.: 13/507,313

(22) Filed: Jun. 20, 2012

Related U.S. Application Data
(60) Provisional application No. 61/571,076, filed on Jun. 20, 2011.

(51) Int. Cl. F16M 11/04; F16M 11/06

(52) U.S. Cl. 248/121

(57) ABSTRACT

A stand for supporting a flower or plant comprises a circular projection; spaced apart L-shaped legs attached to the circular projection; a V-shaped member spaced away from the circular projection to the L-shaped members; a horizontal support member spaced away from the V-shaped member and attached to the L-shaped legs for adding rigidly to the stand; and spaced apart Z-shaped legs attached to the L-shaped legs and including a horizontal section parallel to the circular projection and a vertical section parallel to the L-shaped legs. A further embodiment provides a stand having a circular projection for supporting a flower or plant; a utility bar for supporting the circular projection; and pivotal leg members attached to the utility bar for arcuate movement in a supporting position and in a collapsed position for non-use of the stand. The stand structure allows lawn work to be performed around and/or beneath the stand.

### CROSS REFERENCE TO RELATED PATENT APPLICATION

This application claims priority to U.S. Provisional Patent Application Ser. No. 61/571,076, filed Jun. 20, 2011, the disclosure of which is incorporated herein by reference in its entirety.

### 1. FIELD OF THE INVENTION

The invention relates to a stand for supporting a flower or a plant, and which stand may be placed in a desired location, such as, for example, at the base of a headstone or in a landscape of a business or residence, and which stand is constructed to allow mowing and/or trimming near and/or beneath the stand without interference from the stand.

### 2. DESCRIPTION OF RELATED ART

Headstones, also typically referred to as tombstones or gravestones, come in a variety of shapes, sizes and surfaces. It is customary to place flowers or other decorations adjacent to or on headstones or other grave markers. Cemetery grounds keepers find that memorials placed on the ground near a grave become obstacles which are difficult to maneuver around while mowing and trimming. Consequently, cemeteries have promulgated rules that require decorations placed on the ground, such as flowers, plants, plastic flowers and the like, to be removed prior to the days that mowing and trimming is to occur. Persons placing such decorations near a grave typically wish for them to be displayed as long as possible, sometimes even permanently, and are greatly inconvenienced by the need to return to the grave site to remove such decorations periodically.

Present methods of displaying flowers, plants, and other adornment objects out of the way of the cemetery grounds keepers include such complex mechanisms as the combination grave marker and flower receptacle shown in U.S. Pat. No. 4,722,160 to Davis. This reference discloses a grave marker which has a cover on its top face that can be opened to expose a flower receptacle. This cover, when not being used to display flowers, can be folded down and out of the way, thereby allowing for easy maintenance around the grave marker, or even over the grave marker if it is mounted flush with the ground. Regardless of which position the cover is in, this grave marker does not interfere with normal cemetery maintenance.

U.S. Pat. No. 4,640,045 to Nesbitt, et al. discloses a device for keeping grave site adornments off the ground. This patent discloses a saddle that has been adapted to be clamped to the top portion of the headstone. A holding structure, such as a planter box, is then attached to the saddle and decorative objects can be displayed out of the way of lawnmowers or other cemetery trimming machines.

U.S. Pat. No. 5,062,541 to Quackenbush discloses another type of saddle planter adapted to be mounted on a gravestone. This saddle planter is attached to the gravestone by brackets with cushioned legs that are designed to supply forces to the front and rear of the gravestone, thereby holding the saddle planter in place while also preventing scratching and marking of the gravestone. Containers of various sizes can be attached to this saddle planter so that the size of the floral display can be enlarged.

U.S. Pat. No. 5,368,266 to Allen discloses an adjustable saddle which can be used on either grave markers or porch deck railings. This adjustable saddle is secured on the top of a grave marker or porch deck railing by spring-mounted opposing pairs of legs. Decorative objects, such as a planter box, can then be attached to the saddle and ornamental objects can be displayed.

U.S. Pat. No. 6,134,818 to DiFillip discloses a headstone planter. This headstone planter has four walls and a concave bottom for securing plants and flowers atop a headstone. The walls and bottom form a notched base that allows the planter to securely rest atop a variety of differently shaped headstones. The notched base accommodates round or flat headstones having either smooth or rough cut surfaces. The planter has drain openings in the bottom and rounded top edges.

Several of the above prior art structures for displaying and/or supporting a flower pot or plant pot out of the way of lawnmowers or other cemetery trimming machines involve planter saddles that are mounted atop the gravestone. Over time, these flowers or plants can wilt and die thereby presenting an unsightly scene in the cemetery environment since these wilted flowers or plants are atop the gravestone and not closer to or behind the gravestone where they can be less conspicuous from the road winding through the cemetery.

U.S. Pat. No. 5,199,213 discloses a cemetery plant pot structure which is arranged for threaded securement within a threaded pedestal bore. The apparatus includes a threaded disk threadedly receivable within the bore and the disk mounting a support rod orthogonally thereto in a coaxial relationship. The pot structure is mounted at an upper terminal end of the rod, wherein the pot structure is arranged to optionally include a lower conical base and a cylindrical base permitting directing of water flow into the pot mounted within the conical base.

Different types of structures for supporting and displaying a flower pot or plant pot have been commercially available for a number of years.

There is a need in the art to provide a stand for supporting a flower or plant which allows work, such as, for example, mowing, trimming, and/or weed-whacking to be performed around and/or beneath the stand.

### SUMMARY OF THE INVENTION

The invention has met this need. The invention relates to a stand for supporting a flower or plant, comprising: a circular projection or loop extending at an angle relative to a horizontal plane; at least two spaced-apart L-shaped legs, each having a short leg and a long leg, the short leg of each of the L-shaped leg members being attached diametrically of the circular projection; a V-shaped member spaced away from the circular projection and arranged approximately mid-length along the long leg of each of the L-shaped leg members and attached to one of the L-shaped leg members; a horizontal support member spaced away from the V-shaped member and extending between and attached to the long leg of each of the L-shaped leg members for adding rigidly to the stand; and at least two spaced-apart stylized Z-shaped leg members, each having an end portion attached to one of the two L-shaped leg members, a horizontal section extending in a horizontal plane parallel to that of the circular projection, and a vertical section extending parallel to the long leg of the L-shaped leg members. A removable circular receptacle may be inserted into and supported by the circular projection, which, in turn, supports the flower or plant. The horizontal section of each stylized Z-shaped leg member and the V-shaped member define a space for allowing work, e.g. mowing and/or trimming, to be performed around and beneath the removable circular receptacle and/or a flower or plant especially when the long leg of each of the L-shaped leg members and the vertical section of each of the stylized Z-shaped leg members are inserted into the ground and the horizontal section of the stylized Z-shaped leg members rests against the ground. Mowing and/or trimming of the grass and/or weeds can be easily performed, for example, around a gravestone in a cemetery when the stand is pushed down into the ground so that the devices for performing these lawn manicure services can be inserted into the space defined by the horizontal section of the stylized Z-shaped leg members and the V-shaped member without being obstructed by the removable circular receptacle and/or flower or plant supported in the stand.

A still further object of the invention is to provide a stand for supporting a flower or plant, comprising: a first projection extending outwardly at a slight angle in a horizontal plane for receiving the flower or plant; at least two L-shaped elongated members each being diametrically attached to the first projection; a second projection extending parallel to the first projection for supporting the flower or plant; at least two stylized Z-shaped elongated members, each having an end portion attached to one of the two L-shaped elongated members, a horizontal section extending outwardly in a plane parallel to the first projection and the second projection, and a vertical section extending parallel to the L-shaped elongated members; the horizontal section of each stylized Z-shaped elongated member and the second projection defining a space for allowing work to be performed near and/or beneath the flower or plant. The stand is structured such that several stands may be stacked together for easy shipping and/or handling.

A still further object of the invention is to provide a stand for receiving and supporting a flower or a plant, comprising: a circular projection extending outwardly at a slight angle having an opening for receiving and supporting the flower or plant; a utility bar for receiving and supporting the circular projection; spaced apart pivotal leg member assemblies, each being attached to the utility bar for arcuate movement in a supporting position and in a collapsible position for non-use of the stand. The utility bar comprises spaced apart openings along its length for supporting the spaced apart pivotal leg member assemblies at the extreme ends of the utility bar and for supporting the circular projection inwardly of the extreme ends. The circular projection is flexible such its diameter can be adjusted to insert its legs into at least two openings of the utility bar in order to accommodate the diameter of the flower or plant being inserted into the stand. That is, the circular projection comprises opposed legs; and the openings of the utility bar cooperate to receive the opposed legs of the circular projection according to the diameter that is required to sufficiently receive and support the flower or plant. In this manner, the diameter of the circular projection is adjustable. If the utility bar has six spaced apart openings inwardly of the extreme ends thereof, of these six spaced apart openings, the two outermost openings can receive the legs of the circular projection to obtain a maximum diameter for receiving the flower or plant. Reduced diameters of the opening of the circular projection can be obtained by inserting the legs of the circular projection into consecutive inwardly spaced apart openings of the utility bar with a minimum diameter being obtained when the legs of the circular projection are inserted in the innermost adjacent openings of the utility bar. Each spaced apart pivotal leg assembly is rotatably mounted in the utility bar by means of a tap member. Each pivotal leg assembly comprises an elongated leg member and a Z-shaped leg member attached to the elongated leg member. A portion of the elongated leg member extends into the utility bar for receiving the tap member which, in turn, secures the pivotal leg assembly to the utility bar. A circular receptacle may be inserted into the circular projection and the flower or plant may be inserted into the circular receptacle. The stand is structured such as to provide a clearance for allowing lawn manicure work to be performed beneath the circular projection and also beneath the receptacle and/or flower or plant. A removable support member may be attached to the utility bar for providing added support to the circular receptacle and/or flower or plant. The pivotal leg assemblies may be arcuately moved inwardly and/or outwardly in a required position for adequate support of the stand and the circular receptacle and/or flower or plant. This stand is structured such that the pivotal leg assemblies may be collapsed in a non-operating position, and the circular projection may be placed against the pivotal leg assemblies for packaging and shipping and/or storage of the stand.

These and other objects of the invention will be better appreciated and understood when the following description is read in light of the accompanying drawings.

### DESCRIPTION OF THE DRAWINGS

FIG. 1 is a front right perspective view of a stand of the invention for supporting a flower or plant.

FIG. 2 is a right side perspective view of the stand of FIG. 1.

FIG. 3 is a right side perspective view of the stand of FIG. 1 supporting a circular receptacle which in turn supports a flower or plant.

FIG. 4 is a left side perspective view of a further embodiment of a stand of the invention for supporting a flower or plant.

FIG. 5 is a right side perspective view of the stand of FIG. 4 supporting a circular receptacle which in turn supports a flower or plant.

FIG. 6 is a top perspective view of a utility bar of the stand of FIG. 4.

FIG. 6A is a partial perspective view of a utility bar of the stand of FIG. 4 illustrating an alternate form of a removable support member inserted into the utility bar for aiding in supporting a flower of plant.

### DESCRIPTION OF THE INVENTION

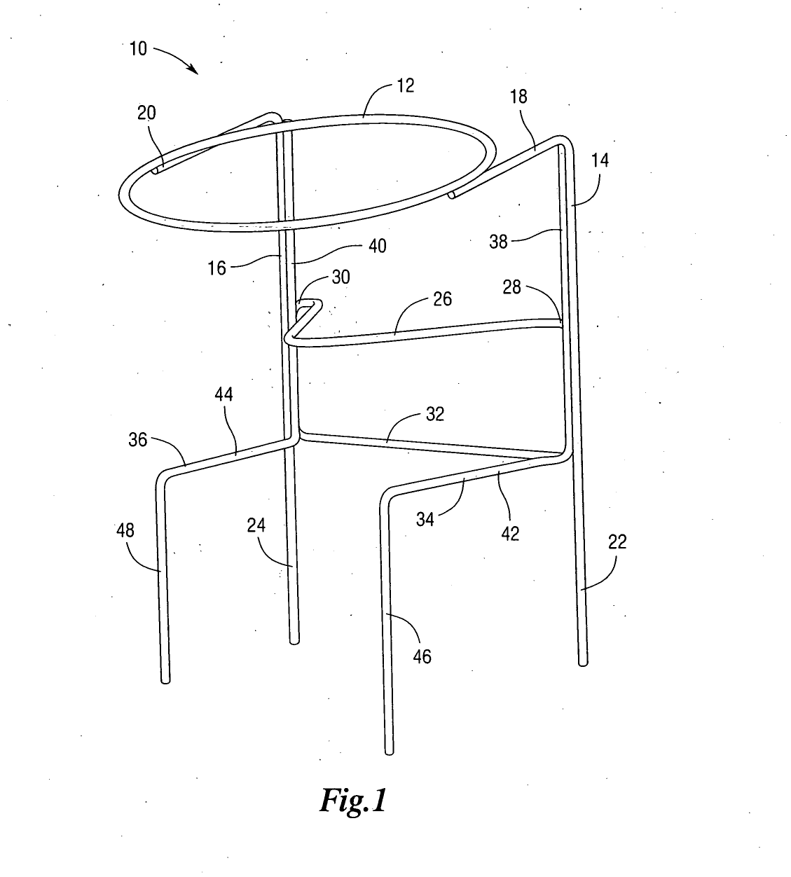

FIGS. 1 through 3 represent an embodiment of the stand of the invention. Referring to FIGS. 1 through 3, the invention provides a stand 10 for supporting a flower or plant. Stand 10 is constructed to rest on top of the ground or to be pushed down into the ground which may be, for example, near the base of a gravestone in a cemetery or in the front or back lawn, while allowing mowing and/or trimming grass and/or weeds near and/or beneath the stand.

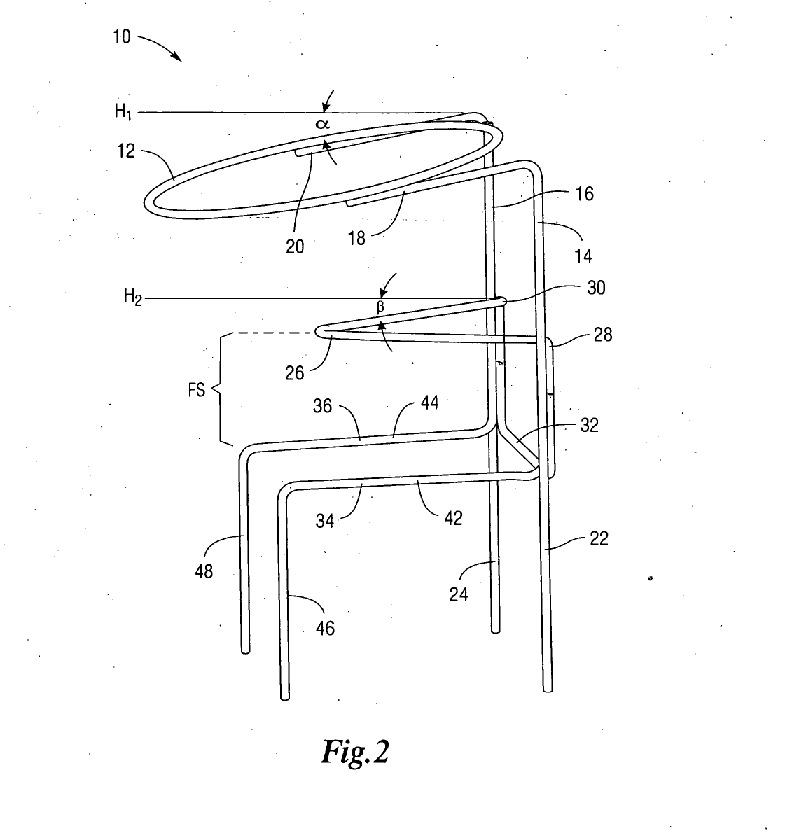

Stand 10 comprises a circular projection or hoop 12 that extends at an angle ranging between about 10 to about 15 degrees relative to a horizontal plane H₁ specifically shown in FIG. 2. Stand 10 further comprises two spaced apart L-shaped leg members 14, 16, each having a short leg 18, 20 and a long leg 22, 24, respectively. As shown particularly in FIGS. 1 and 2, short leg 18, 20 of L-shaped leg members 14, 16 is attached along an opposed diameter of circular projection 12.

A V-shaped member 26 is spaced away from and as shown particularly shown in FIGS. 1 and 2 below circular projection 12. Each of the opposed ends 28, 30 of V-shaped member 26 is attached along the mid-length of the long leg 22, 24 of each of the L-shaped leg members 14, 16. V-shaped member 26 extends at an angle β ranging between about 10 to about 15 degrees in a horizontal plane H₂ that is parallel to the horizontal plane H₁ in which circular projection 12 extends (FIG. 2).

A horizontal member 32 is spaced away from V-shaped member 26 and extends between and is attached to one of the long legs 22, 24 of L-shaped leg members 14, 16. Horizontal member 32 adds rigidly and stability to stand 10. Horizontal member 32 and V-shaped member 26 may be formed from the same piece of wire. For example, the V-shaped member 26 is first formed to extend in a horizontal direction and its opposed ends are bent downwardly through suitable and attached along the long legs 22, 24 of the L-shaped leg members 14, 16 a desired length, and then bent in a horizontal direction through suitable means where the proximal ends of the wire are then welded, soldered or brazed together to form horizontal member 32.

As best shown in FIG. 1, adjacent to horizontal member 32 and L-shaped leg members 14, 16 are two spaced-apart stylized Z-shaped leg members 34, 36. Each stylized Z-shaped leg member 34, 36 has an end portion 38, 40, respectively, that is attached to one of the L-shaped leg members 14, 16; a horizontal section 42, 44 respectively; and a vertical section 46, 48 respectively that extends parallel to long leg 22, 24 of L-shaped members 14, 16, respectively.

The horizontal section 42, 44 of each stylized Z-shaped leg member 34, 36 and V-shaped member 26 defines a space FS (FIG. 2) for allowing work, e.g. mowing and/or trimming of grass and weeds to be performed around and a/or beneath stand 10 when stand 10 is supported by or pushed into the ground. In operation, stand 10 may either be set on top of a surface, e.g. ground, or it may be pushed down into the ground. The latter may be accomplished by the user stepping down onto horizontal sections 42, 44 until horizontal sections 42, 44 and horizontal member 32 are abutting or almost abutting the ground while legs 22, 24 and vertical sections 46, 48 are inserted into the ground. The length of long legs 22, 24 of each L-shaped leg member 14, 16 and the vertical section 46, 48 of each stylized Z-shaped leg member 34, 36 may be shorter than that indicated in FIGS. 1-3. In any event, this length of leg 22, 24 and vertical section 46, 48 would be sufficient to retain stand 10 in an upward anchored position regardless of the environmental conditions, e.g. strong winds.

Stand 10 may be comprised of heavy gauged steel wire, wrought iron, powder coated carbon wire, and/or galvanized wire or it may be manufactured through an injection process. The several components described above for stand 10 may be connected together in the configuration shown in the FIGS. 1 through 3 through resistance welding, spot welding, brazing and/or soldering if stand 10 is made of wire or wrought iron.

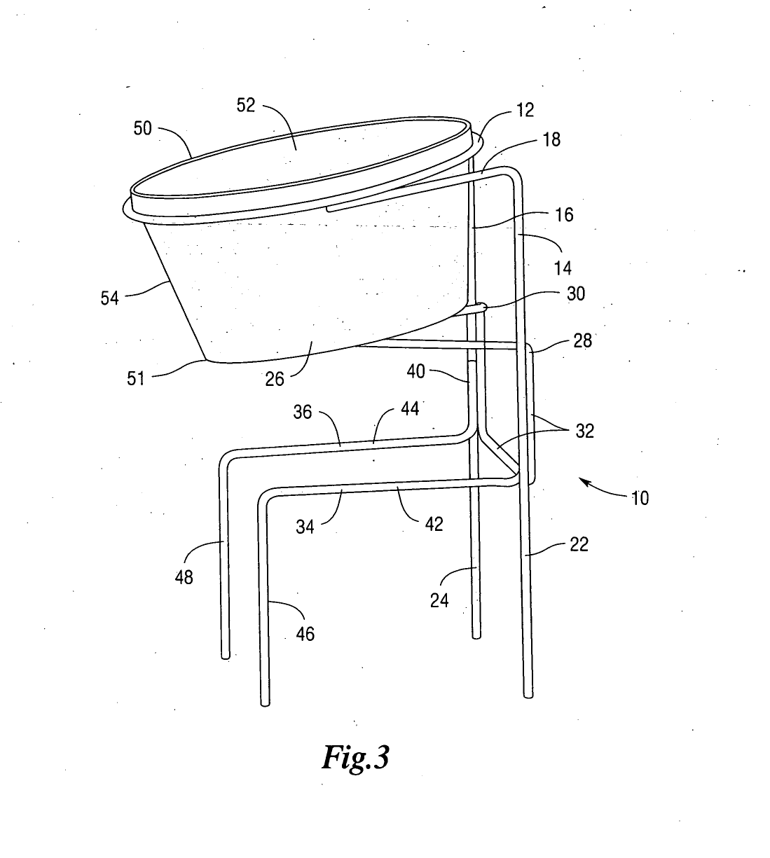

FIG. 3 shows circular projection 12 of stand 10 supporting a circular receptacle 50, which, in turn may be used for receiving and supporting a flower or plant (not shown). Receptacle 50 may be provided with stand 10 at point of sale of the stand or it may be provided separately by the user. Receptacle 50 is preferably removable and has a diameter slightly less than that of circular projection 12 so that receptacle 50 may easily slide down into circular projection 12 and be supported thereby. Receptacle 50 may have a rim 52 which abuts circular projection 12 for support thereof, and may have one or more water drainage apertures or openings (not shown) in its bottom 51. In some instances, receptacle 50 may not have a rim 52, which, in this case, V-shaped member 26 may be used to support receptacle 50 when placed into circular projection 12. Alternatively, a flower or plant may or may not have a rim, and in which instance, V-shaped member 26 may be used to support the flower or plant placed into circular projection 12.

Circular projection 12 of stand 10 extends outwardly at an angle, for example, about 10 to about 15 degrees relative to a horizontal plane to: 1) better display the foliage or flora being supported in receptacle 50; and/or 2) enhance the water drainage in that if the drain openings of the receptacle 50 are positioned at the lowest level of receptacle 50 toward the ground, the water will better drain out of the drain openings of the receptacle 50. As shown in FIG. 3, circular receptacle 50 is large enough that it fits into and is supported by circular projection 12 via its rim 52 and/or by its upper body portion 54. That is, if circular receptacle 50 is positioned straight downwardly into circular projection 12, then receptacle 50 will be supported in the circular projection 12 by its rim 52. If receptacle 50 is positioned at an angle downwardly into the circular projection 12, then receptacle 50 will be supported in circular projection 12 by its upper body portion 54. As shown in FIG. 3, circular receptacle 50 is supported at its bottom 51 by V-shaped member 26.

The positioning of the receptacle 50 in circular projection 12 may be at the discretion of the user of stand 10 depending on the sloping or grade of the ground on which or in which stand 10 is erected for aesthetically displaying the foliage or flora in the circular receptacle 50 and/or depending on the degree of water drainage desired from receptacle 50. In any event, a large enough space FS (FIG. 2) is provided between V-shaped member 26 and horizontal section 42, 44 of each stylized Z-shaped leg member 34, 36 so that mowing and/or trimming of the grass and/or weeds can be easily performed around and/or beneath stand 10 either when stand 10 rests on top of the ground or when it is pushed down into the ground. That is, the devices for performing lawn manicure services can be inserted into the space FS defined by horizontal section 42, 44 and the V-shaped member 26 without being obstructed by stand 10.

Stand 10 of FIGS. 1-3 may be used in the environment of a cemetery, or it may be used as a temporary or permanent fixture in a variety of applications, such as at a business or residence, such as, for example, on lawns and/or backyards and/or hillsides. Stand 10 may have a height, such as, for example, 2 feet, 3 feet, 4 feet or higher.

Even though circular projection 12 is illustrated and described as having a circular configuration, projection 12 may have other suitable configurations, and will broadly be defined herein as a first projection for optionally receiving a receptacle which in turn may receive and support a plant or flower. Member 26 is described as being in a V-shaped configuration, however member 26 may have other suitable configurations, such as, for example, a semi-circular configuration, and will broadly be defined herein as a second projection for aiding in supporting the bottom of the plant or flower in circular projection member 12. Stand 10 is structured such that in an obvious manner several stands 10 may be nested or stacked together for easy storage and/or shipping and/or handling thereof.

Circular receptacle 50 may be large enough that it fits into and is supported by circular projection 12 and/or is supported at its bottom by V-shaped member 26. These several components of stand 10 may be connected together in the configuration shown in the FIGS. 1-3 via a brazing, welding and/or soldering process if stand 10 is made out of wire.

The assembling of stand 10 may be as follows with particular reference to FIGS. 1 and 2. A piece of wire is formed into a circular configuration to form circular projection 12. Two pieces of wire are then formed into an L-shaped configuration to form L-shaped leg members 14, 16 and the short leg 18, 20 is attached to an opposed diameter of circular projection 12. A piece of wire is formed into the V-shaped member 26 and the horizontal member 32 as disclosed herein above and then attached to long legs 22, 24 of L-shaped leg members 14, 16. Two pieces of wire are formed into the stylized Z-shaped configuration to form stylized Z-shaped leg members 34, 36 with end portions 38, 40 attached to long legs 22, 24 of L-shaped leg members 14, 16, their horizontal sections 42, 44 extending outwardly in a horizontal plane and their vertical sections 46, 48 extending downwardly parallel to the long legs 22, 24 of L-shaped members 14, 16.

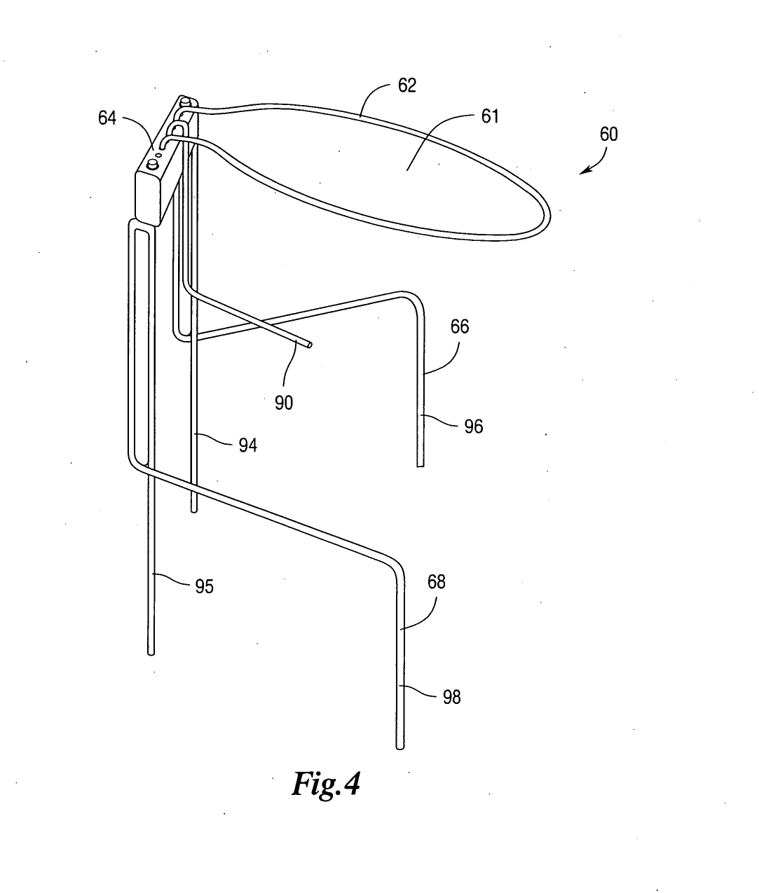

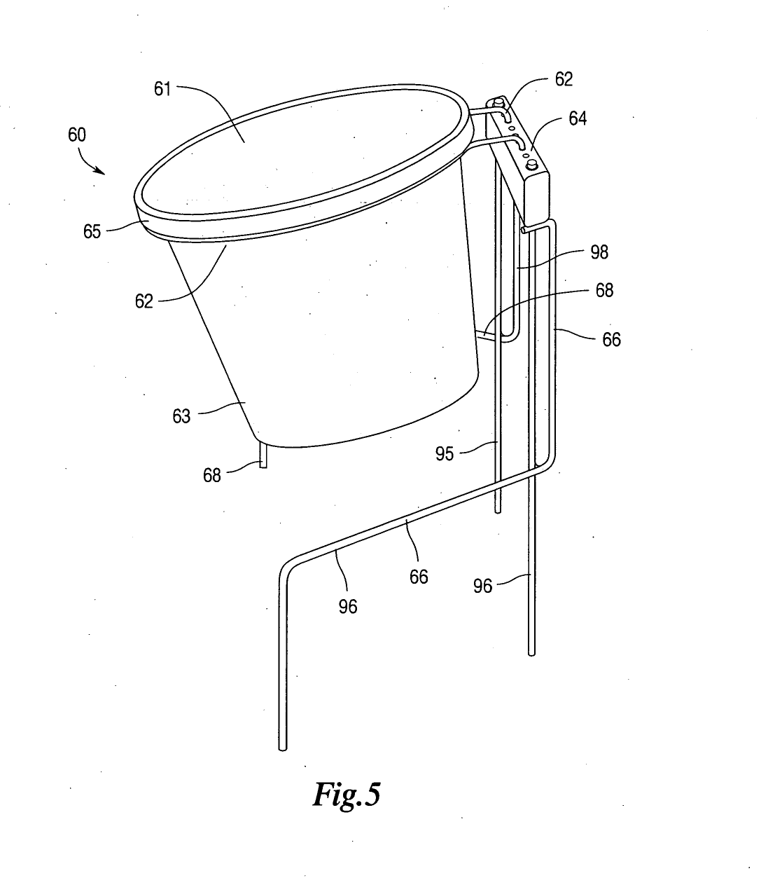

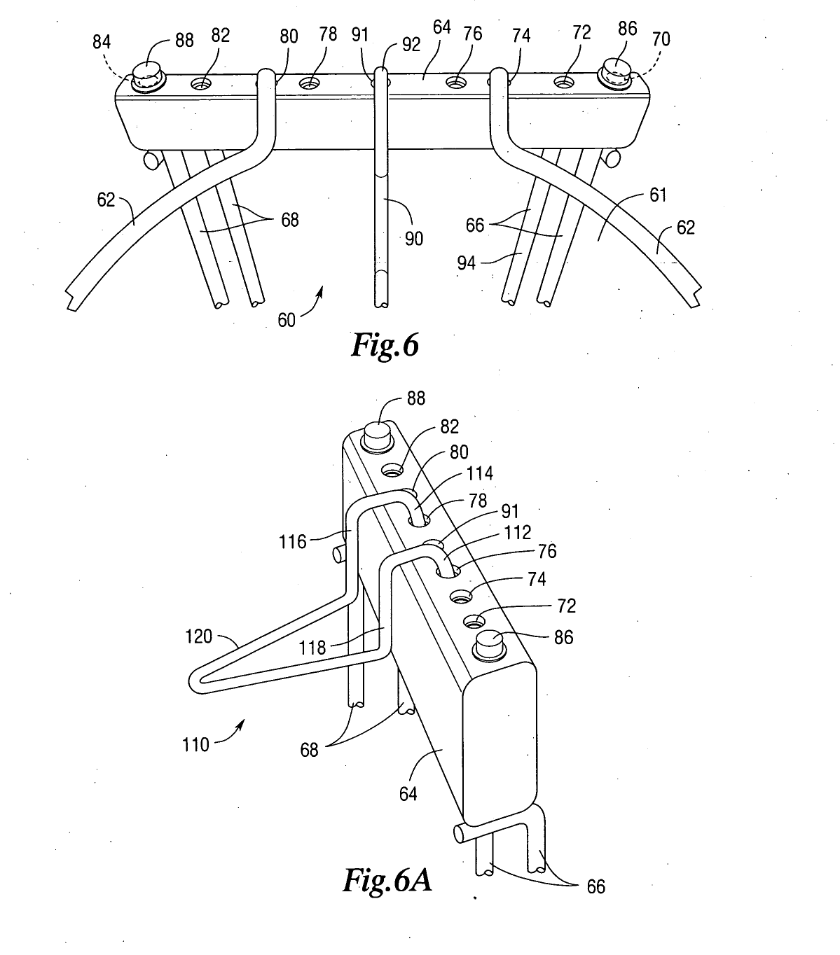

FIGS. 4, 5, 6 and 6A illustrate a further embodiment of a stand 60 of the invention. Referring particularly to FIGS. 4 and 5, stand 60 is structured to receive and support a flower or plant (not shown). Stand 60 comprises a circular projection or hoop 62 having a circular opening 61 for receiving and supporting a removable receptacle 63 via its rim 65 (FIG. 5), which, in turn, receives a flower or plant. Or alternatively, circular projection 62 may directly receive the flower or plant. Circular projection 62 extends at an angle ranging from about 10 to 15 degrees relative to a horizontal plane similar to that described for stand 10. As shown best in FIG. 6 stand 60 further comprises a utility bar 64 and two spaced apart pivotal leg assemblies 66, 68 mounted in utility bar 64 for acuate movement for supporting the flower or plant or in a collapsed position for non-use of stand 60.

FIG. 6 best illustrates utility bar 64. Utility bar 64 comprises a plurality of spaced apart round openings 70, 72, 74, 76, 78, 80, 82, 84 along its length. Openings 70-84 preferably are through openings. Opening 70 receives an upper portion of pivotal leg assembly 66 and pivotal leg assembly 66 is rotatably mounted in and secured to utility bar 64 via a tap member 86. Opening 84 receives an upper portion of pivotal leg assembly 68 and pivotal leg assembly 68 is rotatably mounted in and secured to utility bar 64 via a tap member 88. As is apparent, pivotal leg assemblies 66, 68 extend up through their respective openings 70, 84 and with their respective tap member 86, 88 are free to rotate within utility bar 64 when pivotal leg assemblies 66, 68 are moved in an arcuate path with tap member 86, 88 remaining fixed attached to pivotal leg assemblies 66, 68 and inserted in utility bar 64. Utility bar 64 may be formed via injection molding, it may be die cast, extruded and/or drilled, or it may be made through other suitable processes. Utility bar 64 may be made of stainless steel, fiberglass reinforced plastic, or other suitable materials.

Pivotal leg assemblies 66, 68 with their respective tap member 86, 88 are able to be moved in an accurate path as shown by the double headed curved arrows in FIGS. 4, 5 and 6 inwardly and outwardly relative to circular projection 62 in an operating position to better steady stand 60 in an upright position when stand 60 is placed on a surface, e.g. the ground. An advantage of pivotal leg assemblies 66, 68 is that the arcuate movement of one or both of these leg assemblies 66, 68 can accommodate any type of surface for supporting stand 60. For example, if stand 60 is to be inserted into the ground and a portion of the ground is hard, one or both pivotal leg assemblies 66, 68 can be pivoted to adjust stand 60 so that it can be pushed down into softer ground.

Pivotal leg assemblies 66, 68 can be pivoted away from each other or toward each other to effect a collapsed and non-operating position for stand 60. Pivotal leg assemblies 66, 68 and tap members 86, 88 can be pivoted in this collapsed or non-operating position while still remaining attached to utility bar 64; and circular projection 62 can be removed from utility bar 64 and placed against pivotal leg assemblies 66, 68. In this unassembled state, stand 60 may be packaged for shipment and marketing.

Still referring to FIG. 6, openings 70 and 84 are located at the two extreme ends of utility bar 64. As shown in FIG. 6, opposed vertical legs of circular projection 62 are inserted into openings 74 and 80 and define a diameter for circular opening 61 of circular projection 62. As shown in FIG. 5, this diameter for circular opening 61 of circular projection 62 corresponds to the diameter of receptacle 63 being supported by stand 60. However, the diameter of receptacle 63 may be different from that shown herein and stand 60 provides for this situation. More particularly, circular projection 62 is flexible such that it can be pulled apart and its opposed legs can be inserted into openings 72 and 82 to define a larger diameter, or alternatively, circular projection 62 can be pushed together and its opposed legs can be inserted into openings 76 and 78 to define a smaller diameter for circular projection 62 depending on the required diameter for supporting receptacle 63. If different diameters other than that described herein are required, the opposed legs of circular projection 62 may be inserted into any of the openings 72 through 82 to obtain the required diameter for receiving and supporting receptacle 63 and/or the flower or plant.

Referring particularly to FIGS. 4 and 6, stand 60 further comprises a substantially L-shaped support member 90 releasably attachable to utility bar 64. As shown in FIG. 6, support member 90 has a hooked end 92 that hangs down over the top of utility bar 64 and is engaged in a slot or groove 91 (FIG. 6) which extends down along the width of utility bar 64 on its backside. The use of this support member 90 is optional and its purpose is to aid in supporting receptacle 63 and/or a flower or plant in a manner obvious to those skilled in the art. Support member 90 may particularly be used when receptacle 63 and/or the flower or plant does not have a rim for engaging circular projection 62.

An alternate form for L-shaped support member 90 is illustrated in FIG. 6A at reference number 110. Support member 110 may comprise a semi-circular wire having hooked ends 112, 114 that fit into openings 76, 78 of utility bar 64; vertical legs 116, 118 that hang down from utility bar 64 in a plane parallel to that of pivotal leg assemblies 66, 68 (FIG. 6); and a horizontal V-shaped member 120 for supporting receptacle 63 and/or a flower or plant. Support member 110 may be flexible in a manner similar to circular projection 62 in that it can be adjusted for insertion into openings 72-82 of utility bar 64 not being occupied by circular projection 62 (FIG. 6).

Referring to FIGS. 4, 5 and 6, pivotal leg assemblies 66, 68 comprise an elongated leg member 92, 94 having an upper portion that extends into utility bar 64 for arcuate movement thereof as discussed herein above, and a Z-shaped leg member 96, 98. Each Z-shaped leg member 96, 98 is attached to its respective elongated leg member 92, 94 at two locations along its length. This attachment may be by spot welding, brazing or other suitable processes.

Support members 90, 110 and pivotal leg assemblies 66, 68 may be made of stainless steel or may be made of powder coated carbon steel wire. Stand 60 may have a height such as, for example, 2 feet, 3 feet, 4 feet or greater. Stand 60 may have more than one utility bar for supporting a second projecting member 62. Projection member 62 is structured such that when receptacle member 63 is supported therein, there is enough space to allow lawn manicure work to be performed around and/or under the stand.

Most of the aspects, advantages, operation and function of stand 10 of FIGS. 1-3 as disclosed herein above apply to stand 60 of FIGS. 2-6 in an manner apparent to those skilled in the art, and therefore, will not be discussed herein with respect to stand 60.

Stand 10, 60 may be comprised of any suitable material, such as for example, heavy gauged steel wire, stainless steel, powder coated carbon steel wire, or galvanized wire, or the stand may be an injection molded plastic. A suitable process for attaching the components of the stand may include resistance welding, spot welding, brazing, or soldering. The removable receptacle 50, 63 may be mounted into circular projection 12, 62 for supporting a flower or plant, and this receptacle may include one or more water drainage openings and may be made of plastic. Circular projection 12, 62 of stand 10, 60 extends outwardly at an slight angle relative to a horizontal plane so as to give a slight tilt to removable receptacle 50, 63 and/or to the flower or plant so as to 1) better display the foliage or flora being supported in the circular projection; and/or 2) enhance the water drainage in that if the drain openings of circular receptacle 50, 63 are positioned at the lowest level of circular receptacle 50, 63, the water drains more efficiently from the drain openings.

Even though stands 10 and 60 have been described herein as supporting a flower or plant, it is to be understood that the flower or plant may comprise a pot in which the flower or plant is rooted and that stands 10 and 60 may support this pot with or without the removable receptacle 50, 63.

While the present invention has been described in connection with the embodiments of the figures, it is to be understood that other similar embodiments may be used or modifications and additions may be made to the described embodiment for performing the same function of the present invention without deviating there from. Accordingly, it is intended by the appended claims to cover all such changes and modifications that come within the spirit and scope of the invention.

What is claimed is:

1. A stand for supporting a flower or a plant, comprising:
a projection extending in a substantially horizontal plane and having an opening for receiving and supporting the flower or plant;
spaced apart L-shaped leg members diametrically attached to the projection;
a V-shaped member spaced away from the projection and attached about mid-way along the L-shaped leg members;
a horizontal support member spaced away from the V-shaped member and attached to the L-shaped leg members for adding rigidly to the stand; and
spaced apart Z-shaped leg members attached to the L-shaped leg members and including a horizontal section extending parallel to the projection, and a vertical section extending parallel to the L-shaped leg members;
the horizontal section of the Z-shaped leg members and the V-shaped member defining a space for optionally allowing lawn manicure work to be performed around and/or beneath the projection.

2. The stand of claim 1, wherein the stand is comprised of heavy gauged steel wire.

3. The stand of claim 1, further comprising:
a removable receptacle received in and supported by the projection for receiving and supporting the flower or plant and comprising at least one water drainage aperture.

4. The stand of claim 1, wherein the V-shaped member supports the flower or plant.

5. The stand of claim 1, wherein the stand is comprised of injection molded plastic.

6. A stand for supporting a flower or plant, comprising:
a first projection extending outwardly at an angle relative to a horizontal plane for receiving and supporting the flower or plant;
spaced apart L-shaped leg members each being diametrically attached to the first projection;
a second projection extending parallel to the first projection for supporting a bottom portion of the flower or plant;
spaced apart Z-shaped leg members, each having an end section attached to one of the L-shaped leg members, a horizontal section extending outwardly in a plane parallel to the first projection and the second projection, and a vertical section extending parallel to the L-shaped leg members;
the horizontal section of each Z-shaped leg member defining a space for optionally allowing lawn manicure work to be performed around the stand.

7. A stand for supporting a flower or plant, comprising:
a projection extending outwardly at an angle and having an opening for receiving and supporting the flower or plant;
a utility bar for receiving and supporting the projection;
spaced apart pivotal leg member assemblies, each being attached to the utility bar for arcuate movement in a supporting position and in a collapsible position for non-use of the stand.

8. The stand of claim 7, wherein the utility bar comprises a plurality of openings for supporting the projection and the spaced apart pivotal leg member assemblies.

9. The stand of claim 8, wherein the plurality of openings comprise spaced apart openings located along the utility bar at the extreme ends of the utility bar and inwardly of the extreme ends of the utility bar, and wherein the spaced apart openings located at the extreme ends of the utility bar receive and support one of the spaced apart pivotal leg member assemblies.

10. The stand of claim 9, wherein the projection comprises opposed legs; and
wherein the inward openings of the utility bar cooperate to receive one of the opposed legs of the projection to adjust the opening of the projection to correspond to the dimension of the flower or plant being supported.

11. The stand of claim 10, wherein each of the spaced apart pivotal leg assemblies are rotatably mounted and secured in the utility bar by means of a tap member.

12. The stand of claim 11, wherein each of the spaced apart pivotal leg assemblies comprises an elongated leg member having a portion that extends into the utility bar for arcuate movement thereof and a Z-shaped leg member attached to the elongated leg member.

13. The stand of claim 12, wherein the stand is structured such as to provide a clearance for allowing lawn manicure work to be performed beneath at least the circular projection.

14. The stand of claim 7, further comprises a receptacle supported by the projection for receiving the flower or plant.

15. The stand of claim 7, further comprising a support member attachable to the utility bar for providing support to the flower or plant.
